(19) United States
(12) Patent Application Publication
(10) Pub. No.: US 2023/0093373 A1
(43) Pub. Date: Mar. 23, 2023

(54) PHONOGRAPH RECORD ALBUM PROTECTOR

(71) Applicant: Mollie Stewart, Hendersonville, NC (US)

(72) Inventor: Mollie Stewart, Hendersonville, NC (US)

(21) Appl. No.: 17/921,439

(22) PCT Filed: May 19, 2021
(86) PCT No.: PCT/US21/33153

§ 371 Date: Oct. 26, 2022

Related U.S. Application Data
(60) Provisional application No. 62/704,640, filed on May 19, 2020.

(51) Int. Cl. B65D 81/05; B42F 5/00

(52) U.S. Cl. CPC B65D 81/053; B42F 5/005

(57) ABSTRACT

An album protector includes a removable cover having first and second spaced-apart corner pockets and an elongated U-channel interconnecting the corner pockets. The corner pockets are configured to receive and protect respective corners of an album, and the U-channel is configured to receive and protect an edge of the album. Each corner pocket is generally triangular and forms a right angle defined by a channel side and an album side, and a diagonal side opposite the right angle. The album side of each corner pocket extends perpendicular to the U-channel, and has a length which is less than 50 percent of a total length of the removable cover measured from the right angle of the first corner pocket to the right angle of the second corner pocket.

### TECHNICAL FIELD AND BACKGROUND OF THE DISCLOSURE

The present disclosure relates broadly and generally to a phonograph record album protector and method of protecting and organizing a phonograph record album. In exemplary embodiments, the invention of the present disclosure surrounds the outside of a record album to protect the cardboard jacket and phonograph record inside. In particular, the exemplary album protector surrounds the edges of a phonograph record jacket, preventing degradation of the jacket, while providing durable protection for the inner phonograph record.

Phonograph albums or records are commonly sold and contained within a flat cardboard jacket where three sides are closed and one side remains open to allow the record to be retrieved and later reinserted. The most common problems to arise from this jacket configuration are as follows: First, a jacket with an open end may allow dust into the interior of the jacket where it can degrade the record. The second problem is records, while being handled, can slip out and fall, therefore resulting in damage to the record. Third, cardboard jackets become worn over time due to the nature of the material used. This results in illegible text on the cover and/or spine or complete weakening and breaking of one or more spine all together. Lastly, it can be difficult to locate a record because of the small identifying text on the spine or cover, degraded text on either the spine or the cover, or no identifying text at all. Current means to store records is through the use of storage cabinets or enclosures, which are limiting at least due to the set number of phonograph records the cabinet can hold.

Phonograph record jackets exist to address dust entry into the jacket, records falling out, and legibility of spinal text. However, cardboard jackets commonly used do not address the integrity of more than one exterior spine of the jacket. While there have been advancements made in the design of record jackets, the older, simpler cardboard designs remain the most commonly manufactured. Phonograph record packaging manufactures have not readily adopted modified record j ackets. There are some after-market items designed for the protection and/or storage of records. One such item is an envelope where the entire record-containing jacket fits inside said envelope. These envelopes are often made of clear plastic that tends to yellow, which is esthetically unappealing and may distort images or text. Although this type of record jacket is likely to degrade slower than the cardboard, they may tear, which may ruin their protective purpose.

Another means by which records are stored and organized is through the use of a storage cabinet, box, or enclosure. These enclosures can be limiting at least due to the set number of phonograph records they can hold. The enclosures also add a step in accessibility by keeping them contained. They may take up more floor space since it may be difficult to create vertical storage due to structure and accessibility issues.

### SUMMARY OF EXEMPLARY EMBODIMENTS

Various exemplary embodiments of the present disclosure are described below. Use of the term “exemplary” means illustrative or by way of example only, and any reference herein to “the invention” is not intended to restrict or limit the invention to exact features or steps of any one or more of the exemplary embodiments disclosed in the present specification. References to “exemplary embodiment,” “one embodiment,” “an embodiment,” “various embodiments,” and the like, may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

It is also noted that terms like “preferably”, “commonly”, and “typically” are not utilized herein to limit the scope of the claimed invention or to imply that certain features are critical, essential, or even important to the structure or function of the claimed invention. Rather, these terms are merely intended to highlight alternative or additional features that may or may not be utilized in a particular embodiment of the present invention.

According to one exemplary embodiment, the present disclosure comprises a phonograph record album protector configured for use on a rectangular record album having opposing top and bottom edges, opposing side edges and four corners. The album protector includes a removable top cover and removable bottom cover, both either frictionally or loosely carried on the album. The top cover comprises first and second spaced-apart top corner pockets and an elongated top U-channel interconnecting the top corner pockets. The top corner pockets are configured to closely receive and protect respective top corners of the album, and the top U-channel is configured to closely receive and protect the top edge of the album. The bottom cover is unattached to the top cover and comprises first and second spaced-apart bottom corner pockets and an elongated bottom U-channel interconnecting the bottom corner pockets. The bottom corner pockets are configured to closely receive and protect respective bottom corners of the album, and the bottom U-channel is configured to closely receive and protect the bottom edge of the album.

As used herein, the term “album” refers broadly herein to any combination which includes at least an outside jacket and a phonograph record stored therein. For example, a combination comprising a phonograph record covered by a thin paper sleeve and stored inside a cardboard jacket constitutes an “album.” Alternatively, an album may comprise only a phonograph record stored inside the jacket. The jacket may be constructed of any suitable material used in the industry for storing records.

The term “album protector” refers herein to either one of the top and bottom removable covers used alone on the record album, or both of the removable top and bottom covers used in combination on the record album.

The term “integrally formed” as used herein refers to multiple parts permanently joined together as a single homogenous unit, such as by molding; or alternatively, multiple individual parts which through assembly and by their intended use are permanently joined together, such as by mechanical fastening, adhesives, fusing or the like.

According to another exemplary embodiment, the first and second top corner pockets are generally triangular. Each top corner pocket forms a right angle defined by a channel side and an album side, and a diagonal side opposite the right angle.

According to another exemplary embodiment, the album side of each top corner pocket extends perpendicular to the U-channel, and has a length which is less than 20 percent of a total length of the top cover measured from the right angle of the first top corner pocket to the right angle of the second top corner pocket.

According to another exemplary embodiment, the first and second bottom corner pockets are generally triangular. Each bottom corner pocket forms a right angle defined by a channel side and an album side, and a diagonal side opposite the right angle.

According to another exemplary embodiment, the album side of each bottom corner pocket extends perpendicular to the bottom U-channel, and has a length which is less than 20 percent of a total length of the bottom cover measured from the right angle of the first bottom corner pocket to the right angle of the second bottom corner pocket.

According to another exemplary embodiment, the bottom cover includes an end tab located on the album side of one of the first and second bottom corner pockets. Alternatively, the end tab may be located on the album side of one of the first and second top corner pockets. In yet another embodiment, a top tab may be located on the removable top cover at a location between the right angle of the first top corner pocket and the right angle of the second top corner pocket

According to another exemplary embodiment, the end tab is integrally (permanently) formed with the bottom cover and extends along substantially an entire length of the album side of the bottom corner pocket.

According to another exemplary embodiment, the end tab has width between 0.25 and 1.0 inches.

According to another exemplary embodiment, each of the top corner pockets has spaced apart opposing pocket walls, and perpendicularly-disposed end walls integrally formed with the pocket walls.

According to another exemplary embodiment, the spaced apart pocket walls of each top corner pocket are identically shaped.

According to another exemplary embodiment, the top U-channel has spaced apart channel walls, and an end wall integrally formed with the channel walls.

According to another exemplary embodiment, the spaced apart channel walls of the top U-channel are identically shaped.

According to another exemplary embodiment, the top corner pockets and the top U-channel of the top cover are integrally formed together as a single homogenous unit. The removable top cover may be fabricated of an injection-molded polymer. Alternatively, the top cover may be fabricated in multiple parts and may comprise any other suitable hard material, such as wood, metal, resin, or the like; or soft material, such as a soft plastic, cardboard, leather, fabric, felt or the like.

According to another exemplary embodiment, each of the bottom corner pockets has spaced apart opposing pocket walls, and perpendicularly-disposed end walls integrally formed with the pocket walls.

According to another exemplary embodiment, the spaced apart pocket walls of each bottom corner pocket are identically shaped.

According to another exemplary embodiment, the bottom U-channel has spaced apart channel walls, and an end wall integrally formed with the channel walls.

According to another exemplary embodiment, the spaced apart channel walls of the bottom U-channel are identically shaped.

According to another exemplary embodiment, the bottom corner pockets and the bottom U-channel of the bottom cover are integrally formed together as a single homogenous unit. The removable bottom cover may be fabricated of an injection-molded polymer. Alternatively, the bottom cover may be fabricated in multiple parts and may comprise any other suitable hard material, such as wood, metal, resin, or the like; or soft material, such as a soft plastic, cardboard, leather, fabric, felt or the like.

In another exemplary embodiment, the present album protector comprises only a single removable cover. The exemplary cover has first and second spaced-apart corner pockets and an elongated U-channel interconnecting the corner pockets. As previously described, the corner pockets are configured to closely receive and protect respective corners of the album, and the U-channel is configured to closely receive and protect an edge of the album. Each corner pocket is generally triangular and forms a right angle defined by a channel side and an album side, and a diagonal side opposite the right angle. The album side of each corner pocket extends perpendicular to the U-channel, and has a length which is less than 50 percent of a total length of the removable cover measured from the right angle of the first corner pocket to the right angle of the second corner pocket. In a further embodiment, the album side of each corner pocket has a length which is less than 40 percent of a total length of the removable cover. In yet another embodiment, the album side of each corner pocket has a length which is less than 30 percent of a total length of the removable cover. In yet another embodiment, the album side of each corner pocket has a length which is less than 20 percent of a total length of the removable cover.

In yet another exemplary embodiment, the present disclosure comprises a method for protecting and organizing record albums—the record album consisting of at least a phonograph record and an outside encasement jacket. The removable top and bottom covers of the exemplary album protector described herein are fitted on the outside of the album jacket by light mechanical pressure of the user. The invention is removed by pulling the top and bottom covers away from the outside of the album jacket. Users may elect to protect and organize the record album using both or only a selected one of the removable top and bottom covers.

### BRIEF DESCRIPTION OF THE DRAWINGS

Exemplary embodiments of the present disclosure will hereinafter be described in conjunction with the following drawing figures, wherein like numerals denote like elements, and wherein:

FIG. 1 is a perspective view of the phonograph record album protector according to one exemplary embodiment of the present disclosure, and showing the exemplary album protector applied to top and bottom portions of a record album;

FIG. 2 is an exploded perspective view of the exemplary album protector;

FIG. 3 is a perspective top view of a removable top cover of the exemplary album protector;

FIG. 4 is a perspective bottom view of the removable top cover;

FIG. 5 is a plan view of the removable top cover;

FIG. 6 is an end view of the removable top cover;

FIG. 7 is a top view of the removable top cover;

FIG. 8 is a bottom view of the removable top cover;

FIG. 9 is a perspective top view of a removable bottom cover of the exemplary album protector;

FIG. 10 is a perspective bottom view of the removable bottom cover;

FIG. 11 is a plan view of the removable bottom cover;

FIG. 12 a first end view of the removable bottom cover showing the end tab;

FIG. 13 is an opposite end view of the removable bottom cover;

FIG. 14 is a top view of the removable bottom cover; and

FIG. 15 is a bottom view of the removable bottom cover.

### DESCRIPTION OF EXEMPLARY EMBODIMENTS AND BEST MODE

The present invention is described more fully hereinafter with reference to the accompanying drawings, in which one or more exemplary embodiments of the invention are shown. Like numbers used herein refer to like elements throughout. This invention may, however, be embodied in many different forms and should not be construed as limited to the embodiments set forth herein; rather, these embodiments are provided so that this disclosure will be operative, enabling, and complete. Accordingly, the particular arrangements disclosed are meant to be illustrative only and not limiting as to the scope of the invention, which is to be given the full breadth of the appended claims and any and all equivalents thereof. Moreover, many embodiments, such as adaptations, variations, modifications, and equivalent arrangements, will be implicitly disclosed by the embodiments described herein and fall within the scope of the present invention.

Although specific terms are employed herein, they are used in a generic and descriptive sense only and not for purposes of limitation. Unless otherwise expressly defined herein, such terms are intended to be given their broad ordinary and customary meaning not inconsistent with that applicable in the relevant industry and without restriction to any specific embodiment hereinafter described. As used herein, the article “a” is intended to include one or more items. Where only one item is intended, the term “one”, “single”, or similar language is used. When used herein to join a list of items, the term “or” denotes at least one of the items, but does not exclude a plurality of items of the list.

For exemplary methods or processes of the invention, the sequence and/or arrangement of steps described herein are illustrative and not restrictive. Accordingly, it should be understood that, although steps of various processes or methods may be shown and described as being in a sequence or temporal arrangement, the steps of any such processes or methods are not limited to being carried out in any particular sequence or arrangement, absent an indication otherwise. Indeed, the steps in such processes or methods generally may be carried out in various different sequences and arrangements while still falling within the scope of the present invention.

Additionally, any references to advantages, benefits, unexpected results, or operability of the present invention are not intended as an affirmation that the invention has been previously reduced to practice or that any testing has been performed. Likewise, unless stated otherwise, use of verbs in the past tense (present perfect or preterit) is not intended to indicate or imply that the invention has been previously reduced to practice or that any testing has been performed.

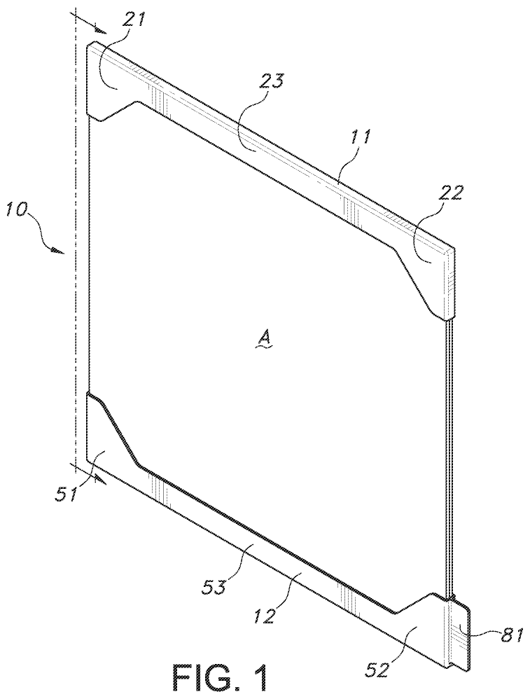

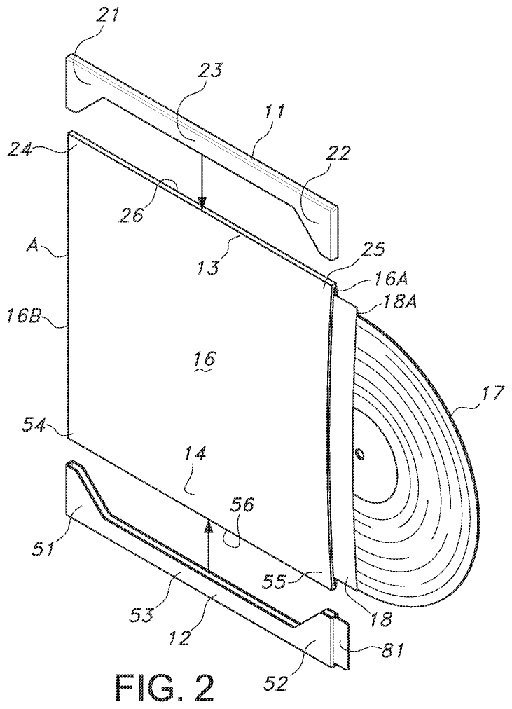

Referring now specifically to the drawings, a phonograph record album protector according to one exemplary embodiment of the present disclosure is illustrated in FIGS. 1 and 2, and shown generally at broad reference numeral 10. The exemplary album protector 10 incorporates one or both of a removable top cover 11 and removable bottom cover 12 applied, respectively, to top and/or bottom portions 13, 14 of a standard rectangular record album “A”. Such record albums typically include a relatively thick outer cardboard jacket 16 open along one side edge 16A to receive a phonograph record 17. The outer jacket 16 is closed along its other 3 edges with the spine 16B opposite the open edge 16A containing information such as the artist name, album title, and a reference or catalog number. The phonograph record 17 may be further protected inside a thin inner paper sleeve 18. The inner sleeve 18 is likewise open along one side edge 18A to receive the record 17, and is closed along its other 3 side edges.

One or both major surfaces of the outer jacket 16 are often strategically designed to reflect the brand and image of the artist or band, and will generally incorporate carefully selected colors, typography, imagery and other indicia. The jacket 16 may also include the artist or band and album name, a track list, and licensing and legal information. In exemplary embodiments, the present album protector 10 is designed to minimize visual obstruction of this carefully designed indicia and information on the major surfaces and spine of the jacket 16, while also protecting and reinforcing delicate areas of the album “A” subject to wear and damage.

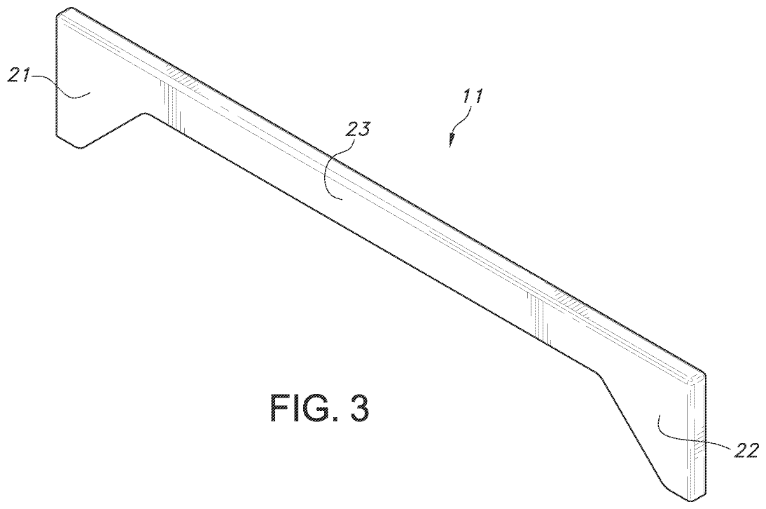

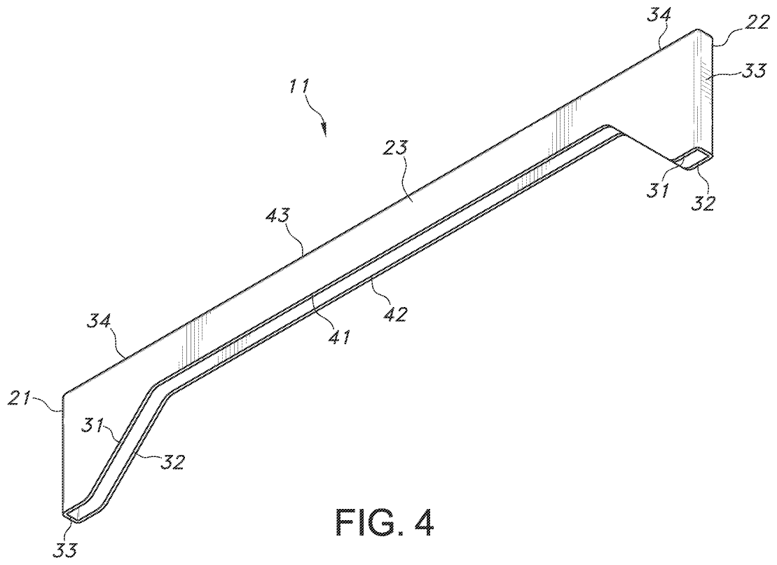

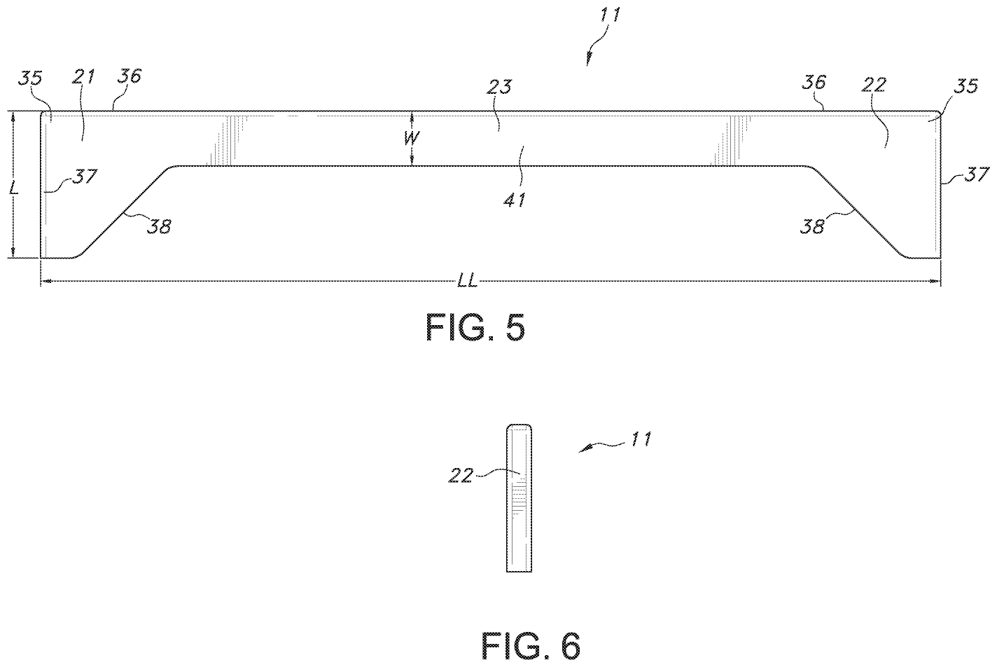

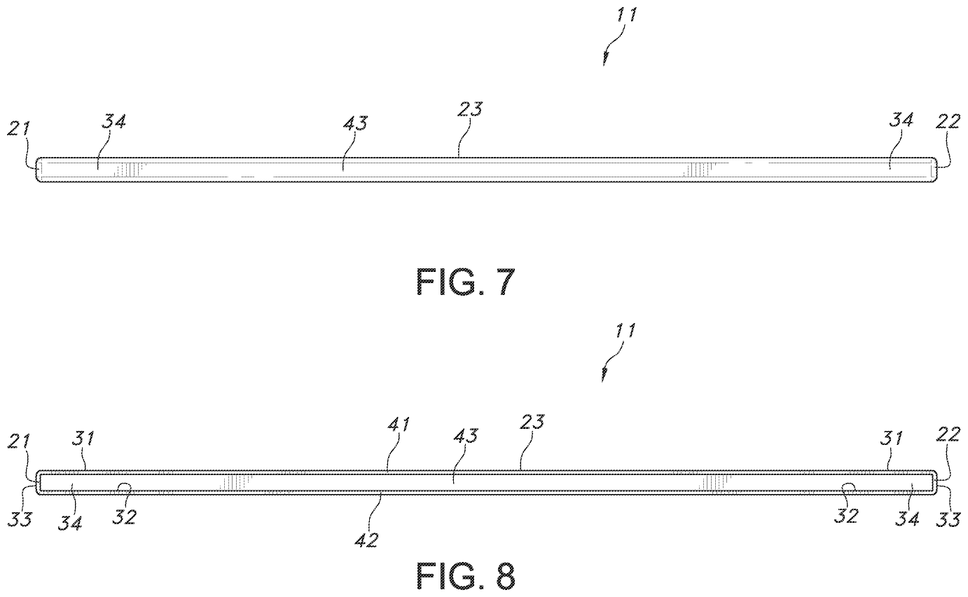

Referring FIGS. 1, 2 and 3-8, the removable top cover 11 of the exemplary album protector 10 is frictionally (or loosely) carried on the album “A”, and comprises first and second spaced-apart top corner pockets 21, 22 and an elongated top U-channel 23 interconnecting the corner pockets 21, 22. The two corner pockets 21, 22 are identically shaped and configured to closely receive and protect respective top corners 24, 25 of the album “A”, and the top U-channel 23 is configured to closely receive and protect the top edge 26 of the album “A”. Each corner pocket 21, 22 has identical spaced apart opposing pocket walls 31, 32 and perpendicularly-disposed end walls 33, 34 integrally formed with the pocket walls. In the exemplary embodiment shown, the corner pocket 21, 22 is generally triangular (See FIG. 5) and forms a right angle 35 defined by a channel side 36 and an album side 37, and a diagonal side 38 opposite the right angle 35. The album side 37 of each corner pocket 21, 22 extends perpendicular to the U-channel 23, and has a length “L” which is less than 20 percent of a total length “LL” of the top cover 11 measured from the right angle 35 of the first top corner pocket 21 to the right angle 35 of the second top corner pocket 22. In one specific example, the total length of the top cover 11 is 12.25 inches and the length of each album side 37 is 2.0 inches.

The elongated U-channel 23 of the exemplary top cover 11 extends between and interconnects the first and second corner pockets 21, 22, and comprises spaced apart channel walls 41, 42 and an end wall 43 integrally formed with the channel walls. The channel walls 41, 42 are identically shaped having a common width dimension “W” of less than 1.0 inches, and are sufficiently spaced-apart (e.g., 0.22 inches) to frictionally or loosely engage the top edge 26 of the album “A”. In one example, the corner pockets 21, 22 and U-channel 23 of the top cover 11 are integrally molded together as a single homogenous unit.

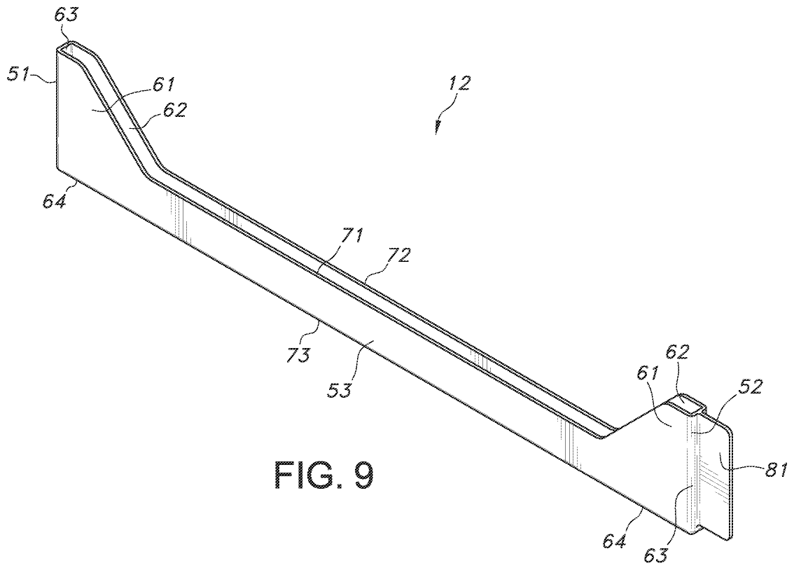

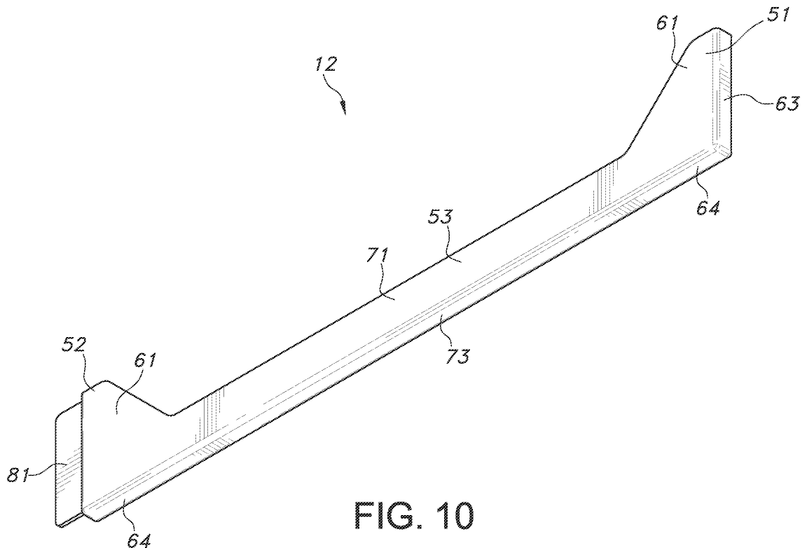

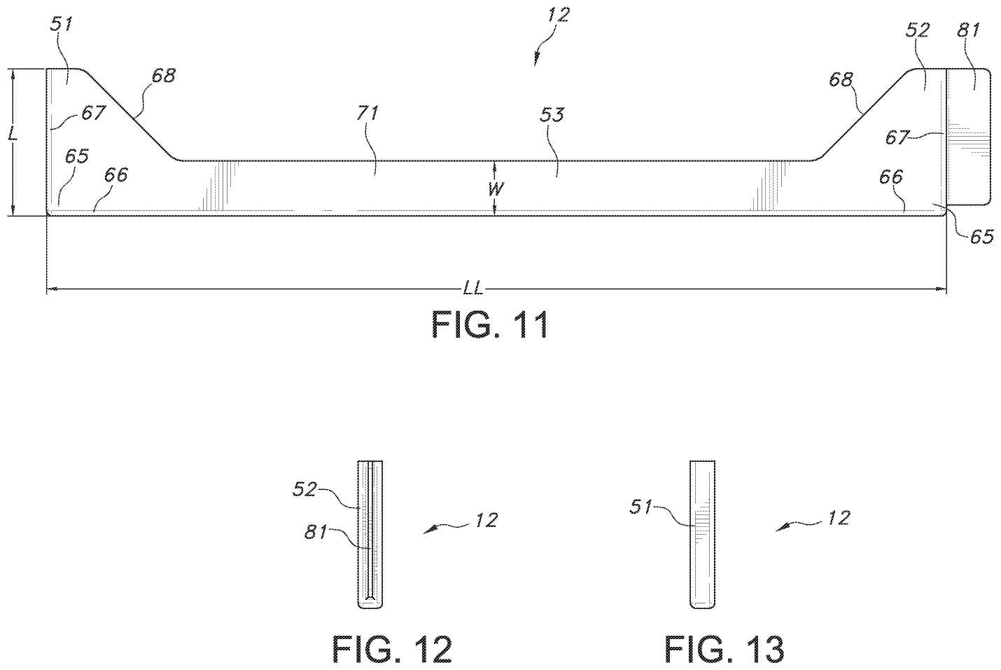

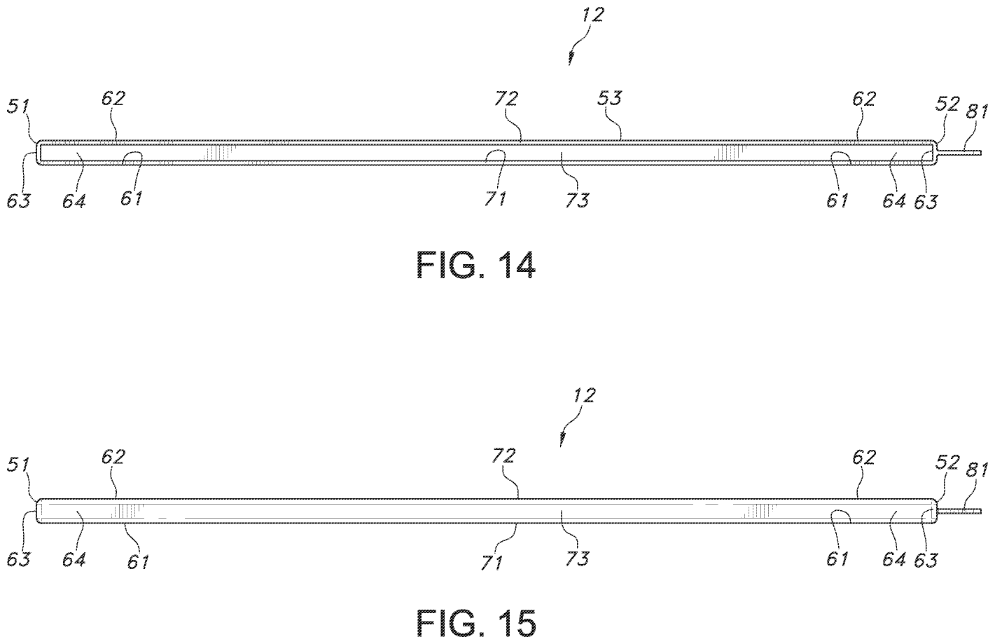

The removable bottom cover 12 of the exemplary album protector 10 is best illustrated in FIGS. 1, 2 and 9-15. Like top cover 11, the bottom cover 12 is frictionally or loosely applied to the album “A”, and comprises first and second spaced-apart bottom corner pockets 51, 52 and an elongated bottom U-channel 53 interconnecting the corner pockets. The two corner pockets 51, 52 are identically shaped and configured to closely receive and protect respective bottom corners 54, 55 of the album “A”, and the bottom U-channel 53 is configured to closely receive and protect the bottom edge 56 of the album “A”. Each corner pocket 51, 52 has identical spaced apart opposing pocket walls 61, 62 and perpendicularly-disposed end walls 63, 64 integrally formed with the pocket walls 61, 62. Like top corner pockets 21, 22, the bottom corner pocket 51, 52 is generally triangular (See FIG. 11) and forms a right angle 65 defined by a channel side 66 and an album side 67, and a diagonal side 68 opposite the right angle 65. The album side 67 of each corner pocket 51, 52 extends perpendicular to the U-channel 53, and has a length “L” which is less than 20 percent of a total length “LL” of the bottom cover 12 measured from the right angle 65 of the first bottom corner pocket 51 to the right angle 65 of the second bottom corner pocket 52. In one specific example, the total length of the bottom cover 12 is 12.25 inches and the length of each album side 67 is 2.0 inches.

The elongated U-channel 53 of the exemplary bottom cover 12 extends between and interconnects the first and second corner pockets 51, 52, and comprises spaced apart channel walls 71, 72 and an end wall 73 integrally formed with the channel walls. The channel walls 71, 72 are identically shaped having a common width dimension “W” of less than 1.0 inches, and are sufficiently spaced-apart (e.g., 0.22 inches) to frictionally or loosely engage the bottom edge 56 of the album “A”. In one example, the corner pockets 51, 52 and U-channel 53 of the bottom cover 12 are integrally molded together as a single homogenous unit.

Additionally, in one exemplary embodiment the removable bottom cover 12 may include an end tab 81 located on the album side 67 of one of the first and second bottom corner pockets 51, 52. The end tab 81 is used to label the record album “A”, as a means of organization, and may be either integrally (permanently) formed with the bottom cover 12 or separately attached. The exemplary tab 81 extends along substantially an entire length of the album side 67 of the bottom corner pocket 52, and has an exemplary width “WW” of between 0.25 and 1.0 inches. In alternative embodiments, the end tab 81 may be located on the album side 37 of one of the first and second top corner pockets 21, 22. In yet another embodiment, a top tab (not shown) may be located on the removable top cover 11 at any location between the right angle 35 of the first top corner pocket 21 and the right angle 35 of the second top corner pocket 22.

The removable covers of the album protector described herein may be used alone or in an alternative combination on any selected top, bottom, or sides of the record album. In other words, a removable cover similar to the top cover of the album protector may be applied to a bottom of the record album, while a removable cover similar to the bottom cover of the album protector may be applied to top of the record album. A further removable cover similar to either the top or bottom covers may be applied to one or both sides of the record album. In still further exemplary embodiments, the present album protector may comprise only one or more corner pockets as described herein—each individual corner pocket being unattached to a U-channel or other element. The individual corner pocket(s) may be used alone on the record album or in combination with one of the removable top and bottom covers of the exemplary album protector. The individual corner pocket may also comprise a label tab.

For the purposes of describing and defining the present invention it is noted that the use of relative terms, such as “substantially”, “generally”, “approximately”, and the like, are utilized herein to represent an inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

Exemplary embodiments of the present invention are described above. No element, act, or instruction used in this description should be construed as important, necessary, critical, or essential to the invention unless explicitly described as such. Although only a few of the exemplary embodiments have been described in detail herein, those skilled in the art will readily appreciate that many modifications are possible in these exemplary embodiments without materially departing from the novel teachings and advantages of this invention. Accordingly, all such modifications are intended to be included within the scope of this invention as defined in the appended claims.

In the claims, any means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. Unless the exact language “means for” (performing a particular function or step) is recited in the claims, a construction under 35 U.S.C. § 112(f) [or 6th paragraph/pre-AIA] is not intended. Additionally, it is not intended that the scope of patent protection afforded the present invention be defined by reading into any claim a limitation found herein that does not explicitly appear in the claim itself.

What is claimed:

1. An album protector configured for use on a rectangular record album having opposing top and bottom edges, opposing side edges and four corners, said album protector comprising:
a removable top cover comprising first and second spaced-apart top corner pockets and an elongated top U-channel interconnecting said top corner pockets, and said top corner pockets configured to receive and protect respective top corners of the album, and said top U-channel configured to receive and protect the top edge of the album; and
a removable bottom cover unattached to said top cover and comprising first and second spaced-apart bottom corner pockets and an elongated bottom U-channel interconnecting said bottom corner pockets, and said bottom corner pockets configured to receive and protect respective bottom corners of the album, and said bottom U-channel configured to receive and protect the bottom edge of the album.

2. The album protector according to claim 1, wherein said first and second top corner pockets are generally triangular, each top corner pocket forming a right angle defined by a channel side and an album side, and a diagonal side opposite the right angle.

3. The album protector according to claim 2, wherein the album side of each top corner pocket extends perpendicular to said U-channel, and has a length which is less than 20 percent of a total length of said top cover measured from the right angle of said first top corner pocket to the right angle of said second top corner pocket.

4. The album protector according to claim 1, wherein said first and second bottom corner pockets are generally triangular, each bottom corner pocket forming a right angle defined by a channel side and an album side, and a diagonal side opposite the right angle.

5. The album protector according to claim 4, wherein the album side of each bottom corner pocket extends perpendicular to said bottom U-channel, and has a length which is less than 20 percent of a total length of said bottom cover measured from the right angle of said first bottom corner pocket to the right angle of said second bottom corner pocket.

6. The album protector according to claim 5, wherein said bottom cover comprises an end tab located on the album side of one of said first and second bottom corner pockets.

7. The album protector according to claim 6, wherein said end tab is integrally formed with said bottom cover and extends along substantially an entire length of the album side of said bottom corner pocket.

8. The album protector according to claim 7, wherein said end tab has width between 0.25 and 1.0 inches.

9. The album protector according to claim 1, wherein each of said top corner pockets comprises spaced apart opposing pocket walls, and perpendicularly-disposed end walls integrally formed with said pocket walls.

10. The album protector according to claim 9, wherein said spaced apart pocket walls of each top corner pocket are identically shaped.

11. The album protector according to claim 10, wherein said top U-channel comprises spaced apart channel walls, and an end wall integrally formed with said channel walls.

12. The album protector according to claim 11, wherein said spaced apart channel walls of said top U-channel are identically shaped.

13. The album protector according to claim 12, wherein said top corner pockets and said top U-channel of said top cover are integrally formed together as a single homogenous unit.

14. The album protector according to claim 1, wherein each of said bottom corner pockets comprises spaced apart opposing pocket walls, and perpendicularly-disposed end walls integrally formed with said pocket walls.

15. The album protector according to claim 14, wherein said spaced apart pocket walls of each bottom corner pocket are identically shaped.

16. The album protector according to claim 15, wherein said bottom U-channel comprises spaced apart channel walls, and an end wall integrally formed with said channel walls.

17. The album protector according to claim 16, wherein said spaced apart channel walls of said bottom U-channel are identically shaped.

18. The album protector according to claim 17, wherein said bottom corner pockets and said bottom U-channel of said bottom cover are integrally formed together as a single homogenous unit.

19. An album protector configured for use on a rectangular record album having opposing top and bottom edges, opposing side edges and four corners, said album protector comprising:
a removable cover comprising first and second spaced-apart corner pockets and an elongated top U-channel interconnecting said corner pockets, and said corner pockets configured to receive and protect respective corners of the album, and said U-channel configured to receive and protect an edge of the album; and
wherein each corner pocket is generally triangular and forms a right angle defined by a channel side and an album side, and a diagonal side opposite the right angle; and
wherein the album side of each corner pocket extends perpendicular to said U-channel, and has a length which is less than 50 percent of a total length of said removable cover measured from the right angle of said first corner pocket to the right angle of said second corner pocket.

20. The album protector according to claim 19, and comprising an end tab located on the album side of one of said first and second corner pockets.
